(19) United States
(12) Patent Application Publication
(10) Pub. No.: US 2014/0112449 A1
(43) Pub. Date: Apr. 24, 2014

(54) SYSTEM AND METHOD FOR COLLIMATING X-RAYS IN AN X-RAY TUBE

(71) Applicant: GENERAL ELECTRIC COMPANY, Schenectady, NY (US)

(72) Inventors: Yun Zou, Clifton Park, NY (US); Scott Stephen Zelakiewicz, Niskayuna, NY (US); Floribertus P. M. Heukensfeldt Jansen, Ballston Lake, NY (US); Mark Alan Frontera, Ballston Lake, NY (US); Jeffrey Wayne Eberhard, Albany, NY (US); Fengfeng Tao, Clifton Park, NY (US); Xi Zhang, Ballston Lake, NY (US)

(73) Assignee: GENERAL ELECTRIC COMPANY, Schenectady, NY (US)

(21) Appl. No.: 13/654,584

(22) Filed: Oct. 18, 2012

(51) Int. Cl. G21K 1/02; H01J 35/02

(52) U.S. Cl. 378/121; 378/150

(57) ABSTRACT

An apparatus and method for providing a predefined x-ray field is presented. Briefly in accordance with one aspect of the present disclosure, the apparatus includes a cathode unit configured to emit electrons within a vacuum chamber. The apparatus further includes an anode unit configured to generate x-rays when the emitted electrons impinge on a target surface of the anode unit. Also, the apparatus includes a collimating unit comprising a primary set of blades disposed in the vacuum chamber at a first distance from the anode unit for collimating the generated x-rays to provide the predefined x-ray field at a detector.

### BACKGROUND

Embodiments of the present disclosure relate generally to an x-ray tube, and more particularly to a system and a method for collimating x-rays in the x-ray tube.

Traditional x-ray imaging systems include an x-ray source and a detector array. The x-ray source generates x-rays that pass through an object under scan. These x-rays are attenuated while passing through the object and are received by the detector array. The detector array includes detector elements that produce electrical signals indicative of the attenuated x-rays received by each detector element. Further, the produced electrical signals are transmitted to a data processing system for analysis, which ultimately produces an image.

Typically, the x-ray source includes an x-ray tube that generates x-rays when an electron beam impinges on a target surface of an anode. Further, the x-ray source includes a collimator that is used for collimating these generated x-rays so that an x-ray field is created at the object that is under scan. Typically, the collimator is used to shield or attenuate the x-rays that are not passing towards the object.

In a conventional x-ray imaging system, the collimator is positioned outside the x-ray tube to collimate or shield the x-rays generated by the x-ray tube. In one example, the collimator is attached to a tube casing that is positioned outside the x-ray tube. Since the collimator is positioned outside the x-ray tube and the x-rays magnify while passing towards the object, a collimator of a large size is required to collimate or shield these x-rays. Particularly, the conventional collimator includes collimator blades that have a size of about 50 mm by 100 mm. Also, the collimator assembly may have a weight of about 5-15 lb which could account for about 25-40% of the total weight of the x-ray source/system for a small integrated x-ray tube and high voltage power supply system, depending on source power and voltage. Moreover, the collimator housing walls are provided with lead lining to shield the scattered x-rays, which in turn increases the weight of the collimator. In addition, as the shielding blades are heavy in weight and large in size, adjusting these blades to obtain a desired x-ray field at the detector is very difficult.

Thus, there is a need for an improved method and structure for reducing the overall weight and size of the collimator. Also, to improve the collimating process for obtaining a desired or predefined x-ray field at the detector.

### BRIEF DESCRIPTION

Briefly in accordance with one aspect of the present disclosure, an apparatus for providing a predefined x-ray field is presented. The apparatus includes a cathode unit configured to emit electrons within a vacuum chamber. The apparatus further includes an anode unit configured to generate x-rays when the emitted electrons impinge on a target surface of the anode unit. Also, the apparatus includes a collimating unit comprising a primary set of blades disposed in the vacuum chamber at a first distance from the anode unit for collimating the generated x-rays to provide a predefined x-ray field at a detector.

In accordance with a further aspect of the present disclosure, a method for providing a predefined x-ray field is presented. The method includes emitting, by a cathode unit, electrons toward an anode unit. The method further includes generating x-rays when the emitted electrons impinge on a target surface of the anode unit. Also, the method includes collimating, by a primary set of blades, the generated x-rays within a vacuum chamber for providing the predefined x-ray field at a detector, wherein the primary set of blades is disposed in the vacuum chamber at a first distance from the anode unit.

In accordance with another aspect of the present disclosure, a collimating apparatus is presented. The collimating apparatus includes a primary set of blades disposed within a vacuum chamber of an x-ray tube, and configured to provide a predefined x-ray field at a detector. The collimating apparatus further includes a secondary set of blades disposed at a first distance from the primary set of blades, and configured to modify the predefined x-ray field. Also, the collimating apparatus includes a driving unit coupled to the primary set of blades and the secondary set of blades and configured to coordinate position of the primary set of blades and the secondary set of blades.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an x-ray tube, in accordance with aspects of the present disclosure;

FIG. 2 is a diagrammatical representation of a portion of the x-ray tube of FIG. 1, in accordance with aspects of the present disclosure;

FIG. 3 is a diagrammatical representation of a portion of the x-ray tube of FIG. 1 illustrating a collimating unit, in accordance with aspects of the present disclosure; and

FIG. 4 is a flow chart illustrating a method for providing a predefined x-ray field at a detector, in accordance with aspects of the present disclosure.

### DETAILED DESCRIPTION

As will be described in detail hereinafter, various embodiments of exemplary structures and methods for collimating x-rays in an x-ray tube are presented. By employing the methods and the various embodiments of the system described hereinafter, the overall weight of the x-ray system may be substantially reduced. Also, the x-rays generated by the x-ray tube may be easily collimated to have a desired or predefined x-ray field at a detector.

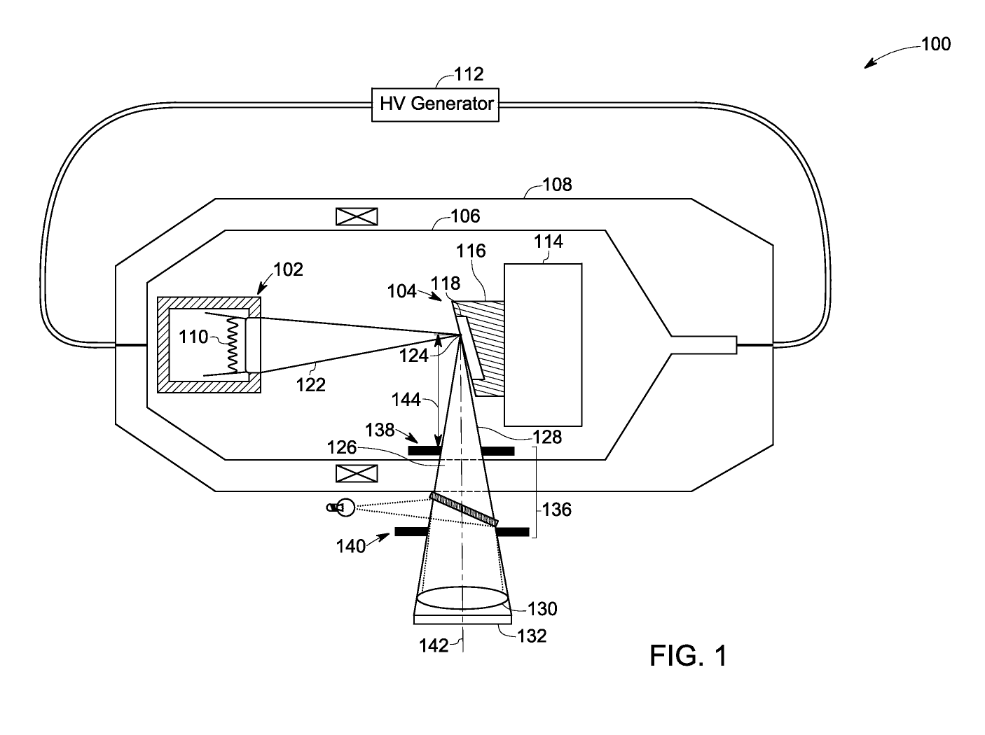

Turning now to the drawings, and referring to FIG. 1, a block diagram of an x-ray tube 100, in accordance with aspects of the present disclosure, is depicted. The x-ray tube 100 is configured for emitting x-rays towards a material sample, a patient, or an object under scan. The x-ray tube 100 includes a cathode unit 102 and an anode unit 104 that are disposed within an evacuated enclosure 106. The evacuated enclosure 106 may be a vacuum chamber that is positioned within a housing 108 of the x-ray tube 100, for example.

The cathode unit 102 includes an electron source 110 for emitting an electron beam 122 towards the anode unit 104. Particularly, an electric current is applied to the electron source 110, such as a filament, which causes the electron beam to be produced by thermionic emission. The electric current is provided from a high voltage (HV) generator 112 that is coupled between the cathode unit 102 and the anode unit 104, as depicted in FIG. 1.

Further, the anode unit 104 includes a support platform 114 and a base 116 having a target surface 118. The base 116 is coupled to the support platform 114 and the target surface 118 is disposed atop of the base 116. Also, the target surface 118 is positioned in the direction of emitted electrons to receive the electrons from the cathode unit 102. Particularly, in the embodiment of FIG. 1, a copper base with a target surface having materials with high atomic numbers (“Z” numbers), such as rhodium, palladium, and/or tungsten, is employed in the anode unit 104. The target surface 118 may be a static target surface or a rotating target surface. It is to be noted that for ease of understanding of the invention, FIG. 1 is shown with the static target surface 118.

During operation, the cathode unit 102 generates the electron beam 122 that is accelerated towards the target surface 118 of the anode unit 104 by applying a high voltage potential between the cathode unit 102 and the anode unit 104. Further, the electron beam 122 impinges upon the target surface 118 at the focal spot 124 and releases kinetic energy as electromagnetic radiation of very high frequency, i.e., x-rays. Particularly, the electron beam 122 is rapidly decelerated upon striking the target surface 118, and in the process, the x-rays are generated therefrom. These x-rays emanate in all directions from the target surface 118. A portion 128 of these x-rays passes through an outlet 126 of the evacuated enclosure 106 to exit the x-ray tube 100 and be utilized to interact with the object 130. Also, these x-rays 128 are attenuated while passing through the object 130 and are received by the detector 132 causing electrical signals indicative of the attenuated x-rays to be produced. Further, the produced electrical signals are transmitted to a data processing system (not shown) for analysis, which ultimately produces an image.

However, the generated x-rays may diverge while travelling towards the object 130 and may provide an x-ray field that is different from a desired or predefined x-ray field at the object 130. The predefined x-ray field is referred to as a desired field of view (FOV) of the x-rays to provide a determined image of the object 130. The x-rays outside the desired FOV may cause extra dose to the patient, and also, these x-rays may scatter and degrade the image quality.

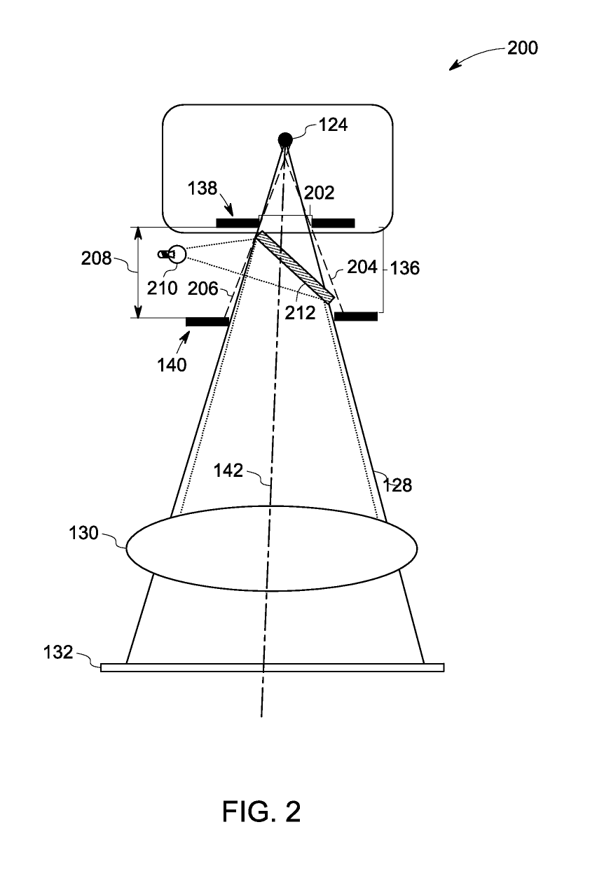

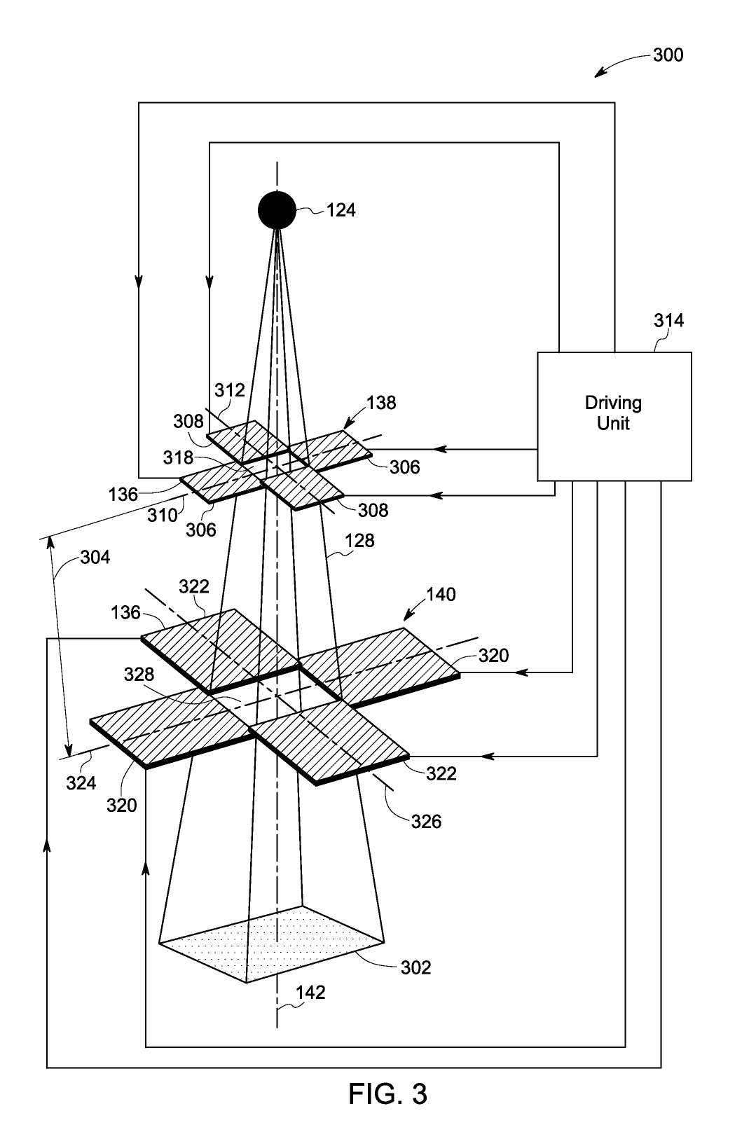

To address these shortcomings or problems, a system 100 as shown in FIG. 1 is employed to collimate a portion 128 of the generated x-rays before the x-rays interact with the object 130. Particularly, the x-ray tube 100 includes a collimating unit 136 that is used for collimating the generated x-rays so that the predefined x-ray field is provided at the object 130. The collimating unit 136 includes a primary set of blades 138 and a secondary set of blades 140. The primary set of blades 138 is disposed within the vacuum chamber 106 and proximate to the target surface 118 to collimate the x-rays 128 before emerging out of the x-ray tube 100. Due to geometry magnification of the x-rays, the primary set of blades 138 is required to move only by a small distance towards a longitudinal axis 142 to cover or provide the predefined x-ray field at the object 130. Further, the secondary set of blades 140 is disposed at a predetermined distance 144 from the primary set of blades 138 to sharpen the edge of the predefined x-ray field at the object 130. In one embodiment, the secondary set of blades 140 is used to modify a shape of the predefined x-ray field at the object 130. It is to be noted that for certain applications that can tolerate larger penumbra, the collimating unit 136 may include only the primary set of blades 138 and may omit the secondary set of blades 140. The aspect of collimating the x-rays and providing the predefined x-ray field at the object is explained in greater detail with reference to FIGS. 2 and 3.

Thus, by employing the collimated unit 136, as depicted in FIG. 1, the generated x-rays are collimated to provide the predefined x-ray field at the object 130. Also, since the x-rays are shielded or collimated within the housing 108 of the x-ray tube 100, the size and the weight of collimating unit 136 are substantially reduced, which in turn reduces the overall size and weight of the x-ray system.

Referring to FIG. 2, a diagrammatical representation of a portion of the x-ray tube of FIG. 1, in accordance with aspects of the present disclosure, is depicted. The x-ray tube 200 includes a collimating unit 136 that is used for collimating or attenuating the x-rays generated from the focal spot 124. Particularly, the collimating unit 136 is used for providing a predefined x-ray field at the detector 132 and/or object 130

In a presently contemplated configuration, the collimating unit 136 includes a primary set of blades 138 that are disposed within a vacuum chamber 106 to collimate the x-rays 128 generated from the target surface 118. The primary set of blades 138 is disposed perpendicular to a longitudinal axis 142, as depicted in FIG. 2. Further, the primary set of blades 138 is adjusted to provide an opening for the x-rays to pass through the x-ray tube 100 and create the predefined x-ray field at the object 130. Also, the primary set of blades 138 is disposed proximate to a focal spot 124 of the target surface 118 so that the x-rays are collimated before emerging out of the x-ray tube 100. Since the primary set of blades is disposed within the vacuum chamber 106 and proximate to the focal spot 124, the size of the blades 138 may be reduced to a range of about 8 mm by about 16 mm.

In addition, due to geometry magnification of the x-rays, the primary set of blades 138 is required to move by a small distance in a direction perpendicular to a longitudinal axis 142 to cover or provide the predefined x-ray field at the object 130. For example, if the blades 138 are at distance of about 20 mm from the anode unit and the source to object distance (SOD) is 1000 mm, the blades 138 are required to move by a distance of about 20/1000=0.02 mm perpendicular to the longitudinal axis 142 to increase/decrease the predefined x-ray field by about 1 mm. Also, to have the predefined x-ray field or field of view of about 40 cm at the object 130, the blades 138 need to have an opening of about 8 mm. Because the range of movement of the primary set of blades 138 is small, the transverse dimension of each of the blades 138 may be substantially reduced. For example, the size of the blades 138 is about 8 mm by about 16 mm to provide enough margins for coverage. Also, the movement of the primary set of blades 138 is controlled by a driving unit (not shown in FIG. 2), which is explained in greater detail with reference to FIG. 3.

Further, the thickness of the primary set of blades 138 depends on the material used. For example, for tungsten (W), the mass attenuation for beam energy of 60 keV is about 3.7 cm²/g. Thus, the primary set of blades 138 of ‘W’ type material with a thickness in a range of about 1 mm to about 2 mm is used for providing a good attenuation of the x-rays. In one embodiment, the primary set of blades 138 may include high Z and vacuum compatible materials. Moreover, as the area and the thickness of the blades 138 are reduced, the weight of the blades is also substantially reduced. In one example, the weight of the blades may be reduced by about 90% compared to the weight of the conventional blades.

In addition, the collimating unit 136 includes a secondary set of blades 140 that are disposed at a predefined distance 208 from the primary set of blade 138, as depicted in FIG. 2. The predefined distance 208 may be in range of about 100 mm to about 250 mm. The secondary set of blades 140 is used to sharpen the edge of the predefined x-ray field. Because the primary set of blades 138 is very close to the focal spot 124, the penumbra is quite large at the detector 132. To overcome this problem, the secondary set of blades 140 is used at the predefined distance 208 from the primary set of blades 138 to sharpen the edge of the x-ray field at the object 130 and/or the detector 132. Particularly, the secondary set of blades 140 is aligned with the primary set of blades 138 to attenuate or shield unwanted x-rays 204, 206 that are not stopped by the primary set of blades 138. For example, the x-rays 204, 206 pass through an opening 202 of the primary set of blades 138. However, these x-rays 204, 206 may diverge while passing towards the object 130 and may not fall within the predefined x-ray field. Thus, the secondary set of blades 140 are used to attenuate or shield these x-rays 204, 206 so that a sharp predefined x-ray field is obtained at the object 130. Also, in one embodiment, the secondary set of blades 140 is used to modify a shape of the predefined x-ray field.

Moreover, as the purpose of the secondary set of blades 140 is to sharpen the edge of the x-ray field, the size of these blades 140 is very low when compared to the conventional collimator blades. For example, the transverse dimension of these blades 140 is about 8 mm by 16 mm. Also, the thickness of these blades 140 is about 2 mm. Further, the blades 140 may be made of lead, tungsten or other similar materials.

In accordance with aspects of the present disclosure, the x-ray tube 200 includes an optical light source 210 and a reflector 212. The optical light source 210 is positioned to provide light optics towards the reflector 212. The reflector 212 is inclined and positioned between the primary set of blades 138 and the secondary set of blades 140, as depicted in FIG. 2. The reflector 212 is used to reflect the light optics towards the object 130 that is under scan. Further, the secondary set of blades 140 is used to collimate the reflected light optics to have a field of view of light optics that is similar to the field of view of x-rays at the object. Particularly, the reflector 212 is used to reflect the light optics or light rays parallel to the collimated x-rays. In one embodiment, the secondary set of blades 140 includes lead in the area of about 8 mm by about 16 mm and the rest is of opaque material to block the optic light. Also, there is minimal shielding required around the secondary set of blades 140 because the scattering from these blades 140 is very small.

Thus, the collimating unit 136 helps in providing the predefined x-ray field at the detector 132. Also, since the collimating unit 136 is miniaturized and integrated with the x-ray tube 100, the overall weight and size of the x-ray system is substantially reduced.

Referring to FIG. 3, a diagrammatical representation of a portion of the x-ray tube of FIG. 1, in accordance with aspects of the present disclosure, is depicted. The x-ray tube 300 includes a collimating unit 136 that is used to collimate the x-rays and provide a predefined x-ray field 302 at a detector. Further, the collimating unit 136 includes a primary set of blades 138 that is disposed proximate to the focal spot 124, and the secondary set of blades 140 that is disposed at a predetermined distance 304 from the primary set of blades 138. It is to be noted that for certain applications that can tolerate larger penumbra, the collimating unit 136 may include only the primary set of blades 138 and may omit the secondary set of blades 140.

In a presently contemplated configuration, the primary set of blades 138 includes a first pair of blades 306 and a second pair of blades 308, where a first axis 310 of the first pair of blades 306 is orthogonal to a second axis 312 of the second pair of blades 308, as depicted in FIG. 3. The first pair of blades 306 is movable along the first axis 310, while the second pair of blades 308 is movable along the second axis 312. Further, the first pair of blades 306 is coupled to a driving unit 314 to move the blades 306 in an outward or inward direction with respect to a longitudinal axis 142. In one embodiment, the driving unit 314 may include one or more actuators for driving the blades. In one example, the actuators may be a vacuum compatible motor or a piezo actuator disposed within the vacuum chamber 106. In another example, the actuators may be disposed outside the vacuum chamber 106.

Similarly, the second pair of blades 308 is coupled to the driving unit 314 to move the blades 308 in an outward or an inward direction with respect to the longitudinal axis 142, as depicted in FIG. 3. By moving the first pair and second pair of blades 306, 308 inward or outward along their respective axis 310, 312, a first opening 318 is provided for the x-rays 128 to pass through the x-ray tube 100. Particularly, the blades 306, 308 are adjusted to have a predefined x-ray field 302 at the object or detector.

Further, since the first pair and the second pair of blades 306, 308 are positioned within the vacuum chamber and proximate to the focal spot 124 of the target surface, the size of these blades 306, 308 may be substantially reduced. For example, the size of each of the blades 306, 308 is of about 8 mm by about 16 mm. In addition, as the size of the blades 306, 308 is reduced, the weight of the blades 306, 308 is also significantly reduced. For example, the weight of each of the blades is in a range of several grams. Moreover, since the blades 306, 308 are of less size and weight, the blades 306, 308 may be easily adjusted or moved using the driving unit 314 to obtain the predefined x-ray field 302 at the detector.

In accordance with aspects of the present disclosure, the secondary set of blades 140 includes a third pair of blades 320 and a fourth pair of blades 322, where a third axis 324 of the third pair of blades 320 is orthogonal to a fourth axis 326 of the fourth pair of blades 322. The third pair of blades 320 is movable along the third axis 324, while the fourth pair of blades 322 is movable along the fourth axis 326. Further, the third pair of blades 320 is coupled to the driving unit 314 to move the blades 320 in an outward or inward direction with respect to the longitudinal axis 142. Similarly, the fourth pair of blades 322 is coupled to the driving unit 314 to move the blades in an outward or inward direction with respect to the longitudinal axis 142, as depicted in FIG. 3.

In addition, by moving the third pair and fourth pair of blades 320, 322 inward or outward along their respective axis 324, 326, a second opening 328 is provided for the x-rays that passed through the first opening 318 of the primary set of blades 13. Particularly, the secondary set of blades 140 is used to shield or attenuate the x-rays that passed through the first opening 318 and are not travelling towards the object. For example, the x-rays generated from the focal spot 124 may pass through the first opening 318 of the primary set of blades 138. However, because of the angle of these x-rays (see x-rays 148 of FIG. 2), these x-rays may diverge after moving out of the first opening 318 and may create an additional x-ray field at the edges of the predefined x-ray field 302. Thus, the secondary set of blades 140 is positioned at the determined distance 304 from the primary set of blades 138 to attenuate or shield these x-rays so that the edges of the predefined x-ray field 302 are sharpened at the detector. In one embodiment, the secondary set of blades is used to modify a shape of the predefined x-ray field.

Additionally, the position of the secondary set of blades 140 is coordinated with the position of the primary set of blades 130 by using the driving unit 314. Particularly, the first set of blades 306 is coordinated with the third set 320 of blades, while the second set of blades 308 is coordinated with the fourth set of blades 322. Also, the driving unit 314 is used to adjust the second opening 328 of the secondary set of blades 140 with the first opening 318 of the primary set of blades 138 so that the generated x-rays pass through these openings 318, 328 and provide the predefined x-ray field at the object and/or the detector.

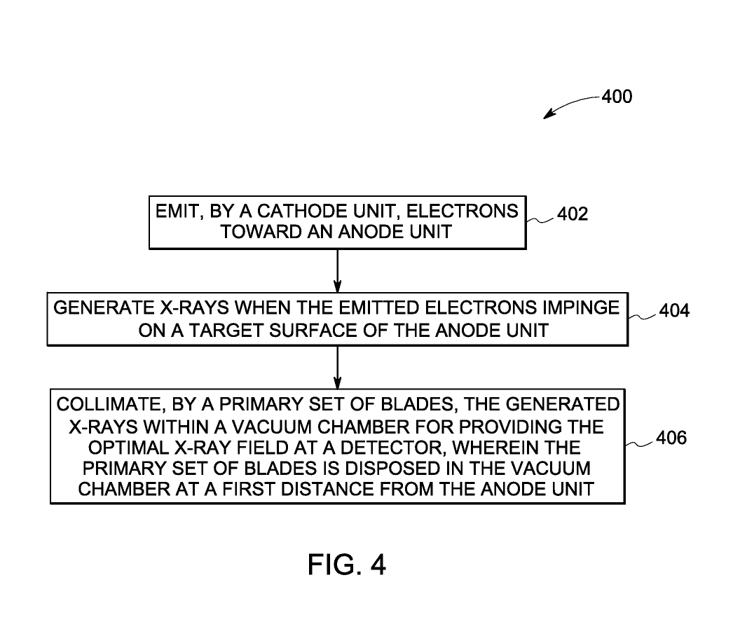

Referring to FIG. 4, a flow chart illustrating a method for providing a predefined x-ray field, in accordance with aspects of the present disclosure, is depicted. For ease of understanding of the present disclosure, the method is described with reference to the components of FIGS. 1-3. The method begins at step 402, where the electrons are emitted toward the anode unit 104. To that end, the cathode unit 102 is configured to emit the electrons toward the anode unit 104. Particularly, an electric current is applied to the electron source, such as a filament 108, which causes the electrons to be produced by thermionic emission.

Subsequently, at step 404, x-rays are generated at the anode unit 104 when the emitted electrons impinge on a target surface 118 of the anode unit 104. Particularly, the electrons are accelerated towards the target surface 118 of the anode unit 104 by applying a high voltage potential between the cathode unit 102 and the anode unit 104. These electrons impinge upon the target surface 118 at a focal spot 124 and release kinetic energy as electromagnetic radiation of very high frequency, i.e., x-rays. A portion 128 of these x-rays may pass through an outlet of the housing 108 and may travel towards the object 130 that is under scan.

Additionally, at step 406, the generated x-rays within a vacuum chamber 106 are collimated for providing the predefined x-ray field 302 at a detector 132. To that end, a collimating unit 136 is used for collimating the x-rays 128 that are passing towards the object 130. Particularly, a primary set of blades 138 is disposed in the vacuum chamber 106 at a first distance 144 from the focal spot 124 to shield or collimate the x-rays 128. The primary set of blades 138 is used for providing the predefined x-ray field 302 at the detector 132. Further, a secondary set of blades 140 is disposed at a second distance 208, 304 from the primary set of blades 138 to sharpen the edges of the predefined x-ray field 302.

Furthermore, the movement of the secondary set of blades 140 is coordinated with the movement of the primary set of blades 138 to have the predefined x-ray field 302 at the detector 132. Particularly, the driving unit 314 is used to drive the primary set and secondary set of blades 138, 140 in a desired direction to have the predefined x-ray field 302 at the object and/or detector. For example, the primary set and the secondary set of blades 138, 140 are moved towards the longitudinal axis 142 to reduce a space of the first and second openings 318, 328. By reducing the space of the first and second openings 318, 322, a narrow x-ray field is provided at the object 130 and/or detector 132. Similarly, by moving the primary set and the secondary set of blades 138, 140 away from the longitudinal axis 142, the space of the first and second openings 318, 328 is increased, which in turn provides a wider x-ray field at the object 130 and/or detector 132.

Moreover, since the primary set of blades 138 is positioned proximate to the target surface 118, a low size and low weight blades are sufficient to collimate the x-rays 128 and to provide the predefined x-ray field 302. Also, since the x-rays 128 are collimated before passing out of the x-ray tube 100, a very low size and very low weight of secondary set of blades 140 is sufficient to fine tune or sharpen the edge of the predefined x-ray field 302. Additionally, since the size of the collimator is reduced, the amount of lead lien on a housing wall (not shown) of the collimator is also substantially reduced. Thus, the total weight of the collimating unit 136 is substantially reduced, which in turn reduces the overall weight of the x-ray system.

The various embodiments of the system and method described hereinabove aid in collimating the x-rays to provide a predefined x-ray field at the object and/or detector. Also, as the x-rays are collimated within the vacuum chamber close to the focal spot, the size and the weight of the blades is substantially reduced. Further, since the weight of blades is reduced, the overall weight of the x-ray system is also substantially reduced.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An apparatus comprising:
a cathode unit configured to emit electrons within a vacuum chamber;
an anode unit configured to generate x-rays when the emitted electrons impinge on a target surface of the anode unit; and
a collimating unit comprising a primary set of blades disposed in the vacuum chamber at a first distance from the anode unit for collimating the generated x-rays to provide a predefined x-ray field at a detector.

2. The apparatus of claim 1, wherein the collimating unit further comprises a secondary set of blades disposed at a second distance from the primary set of blades to further modify a shape of the predefined x-ray field.

3. The apparatus of claim 1, wherein the collimating unit further comprises a secondary set of blades disposed at a second distance from the primary set of blades to sharpen at least an edge of the predefined x-ray field.

4. The apparatus of claim 3, wherein the secondary set of blades collimates at least a portion of the x-rays that are allowed to pass through an outlet of the vacuum chamber to sharpen at least the edge of the predefined x-ray field.

5. The apparatus of claim 3, wherein the collimating unit further comprises a driving unit for moving the primary set of blades and the secondary set of blades in at least one radial direction to change a position of the primary set of blades and the secondary set of blades.

6. The apparatus of claim 5, wherein the position of the secondary set of blades is coordinated with the position of the primary set of blades.

7. The apparatus of claim 3, wherein the primary set of blades comprises at least a first pair of blades and a second pair of blades that are disposed proximate to the anode unit, wherein a first axis of the first pair of blades is different than a second axis of the second pair of blades.

8. The apparatus of claim 7, wherein the first pair of blades is movable along the first axis and the second pair of blades is movable along the second axis.

9. The apparatus of claim 7, wherein the secondary set of blades comprises at least a third pair of blades and a fourth pair of blades that are disposed outside the vacuum chamber, wherein a third axis of the third pair of blades is different than a fourth axis of the fourth pair of blades.

10. The apparatus of claim 9, wherein the third pair of blades is movable along the third axis and the fourth pair of blades is movable along the fourth axis.

11. The apparatus of claim 10, wherein the position of the first pair of blades is coordinated with the position of the third pair of blades.

12. The apparatus of claim 10, wherein the position of the second pair of blades is coordinated with the position of the fourth pair of blades.

13. The apparatus of claim 3 further comprising a reflecting unit disposed between the primary set of blades and the secondary set of blades for reflecting light rays parallel to the collimated x-rays.

14. A method for providing a predefined x-ray field, the method comprising:
emitting, by a cathode unit, electrons toward an anode unit;
generating x-rays when the emitted electrons impinge on a target surface of the anode unit; and
collimating, by a primary set of blades, the generated x-rays within a vacuum chamber for providing the predefined x-ray field at a detector, wherein the primary set of blades is disposed in the vacuum chamber at a first distance from the anode unit.

15. The method of claim 14 further comprising sharpening an edge of the predefined x-ray field by disposing a secondary set of blades at a second distance from the primary set of blades.

16. The method of claim 15 further comprising moving the primary set of blades and the secondary set of blades in at least one radial direction to provide the predefined x-ray field at the detector.

17. The method of claim 16, wherein moving the primary set of blades and the secondary set of blades comprises coordinating the position of the secondary set of blades with the position of the primary set of blades.

18. A collimating apparatus comprising:
a primary set of blades disposed within a vacuum chamber of an x-ray tube, and configured to provide a predefined x-ray field at a detector;
a secondary set of blades disposed at a first distance from the primary set of blades, and configured to modify the predefined x-ray field; and
a driving unit coupled to the primary set of blades and the secondary set of blades and configured to coordinate position of the primary set of blades and the secondary set of blades.

19. The collimating apparatus of claim 18, wherein the secondary set of blades is configured to change a shape of the predefined x-ray field.

20. The collimating apparatus of claim 18, wherein the secondary set of blades is configured to sharpen an edge of the predefined x-ray field.

21. The collimating apparatus of claim 18, wherein the primary set of blades is configured to collimate x-rays generated by an anode unit of the x-ray tube so that the predefined x-ray field is produced at the detector.

22. The collimating apparatus of claim 21, wherein the secondary set of blades is configured to collimate at least a portion of the x-rays that are passed through an outlet of the vacuum chamber to modify the predefined x-ray field.

23. The collimating apparatus of claim 21, further comprising a reflecting unit disposed between the primary set of blades and the secondary set of blades and configured to reflect light rays parallel to the collimated x-rays.
